(19) United States
(12) Patent Application Publication
(10) Pub. No.: US 2008/0165280 A1
(43) Pub. Date: Jul. 10, 2008

(54) DIGITAL VIDEO STABILIZATION WITH MANUAL CONTROL

(76) Inventors: Aaron T. Deever, Pittsford, NY (US); Robert J. Parada, Rochester, NY (US); John R. Fredlund, Rochester, NY (US)

Correspondence Address: Patent Legal Staff;Eastman Kodak Company, 343 State Street, Rochester, NY, 14650-2201, US

(21) Appl. No.: 11/684,751

(22) Filed: Mar. 12, 2007

Related U.S. Application Data
(60) Provisional application No. 60/883,621, filed on Jan. 5, 2007.

(51) Int. Cl. H04N 7/00

(52) U.S. Cl. 348/497; 348/E07.001

(57) ABSTRACT

In a method for altering a video sequence, a first portion of the video sequence is digitally stabilized in accordance with an initial set of image stabilization parameters and displayed to a user. An input from the user is accepted during the displaying. The user input defines a revised set of image stabilization parameters. A second portion of the video sequence is then digitally stabilized in accordance with the revised set of image stabilization parameters and is displayed to the user. A predetermined video frame rate is maintained continuously during and between the displaying steps.

### CROSS REFERENCE TO RELATED APPLICATIONS

This is a 111A application of Provisional Application Ser. No. 60/883,621, filed Jan. 5, 2007.

Reference is made to commonly assigned, co-pending U.S. patent application Ser. No. ______, [Attorney Docket No. 93479], entitled: IMAGE DIGITAL PROCESSING BASED ON EDIT STATUS, filed Mar. 6, 2007, in the names of John R. Fredlund, Aaron T. Deever, Steven M. Bryant, Kenneth A. Parulski, Robert J. Parada, which is hereby incorporated herein by reference.

### FIELD OF THE INVENTION

The invention relates to methods and systems for use of digital video and more particularly relates to digital video stabilization with manual control.

### BACKGROUND OF THE INVENTION

Image stabilization is provided in many cameras to remove jitter from captured video sequences. U.S. Patent Application Publication No. US2006/0274156A1, filed by Rabbani et al. May 17, 2005, entitled “IMAGE SEQUENCE STABILIZATION METHOD AND CAMERA HAVING DUAL PATH IMAGE SEQUENCE STABILIZATION”, discloses a digital video stabilization method, in which digital image stabilization is applied to a captured video. The frames of the video sequence are cropped to a smaller size, as a result of the stabilization.

Other stabilization algorithms with varying computational complexity are known. Such methods are described in Park et al. U.S. Pat. No. 5,748,231, Soupliotis et al. U.S. Patent Application 2004/0001705, Morimura et al. U.S. Pat. No. 5,172,226, Weiss et al. U.S. Pat. No. 5,510,834, Burt et al. U.S. Pat. No. 5,629,988, Lee U.S. Patent Application 2002/0118761, Paik et al. (IEEE Transactions on Consumer Electronics, Vol. 38, No. 3, August 1992), and Uomori et al. (IEEE Transactions on Consumer Electronics, Vol. 36, No. 3, August 1990). These techniques differ in the approaches used to derive estimates of the camera motion, as well as the image warping and cropping used to generate the stabilized image sequence.

None of these techniques help unless they are applied to the video sequence. Many consumer digital cameras lack any video stabilization. This lack can be met by applying image stabilization later in the imaging chain.

U.S. Pat. No. 6,868,190 to Morton and U.S. Pat. No. 6,972,828 to Bogdanowicz et al., disclose procedures for maintaining a desired “look” in a motion picture. “Look” includes such features of an image record as: sharpness, grain, tone scale, color saturation, image stabilization, and noise. Modifying the look of professionally prepared image records raises issues of whether artistic values have been compromised. It is a shortcoming of many playback systems that image records are all automatically modified. With image stabilization, this could be problematic. For example, the movie “Blair Witch Project”, which deliberately included jittery scenes would not be the same with image stabilization applied.

The same thing can apply to consumer video sequences. For example, a video sequence shot on a rickety tourist bus could lose impact if image stabilized. Cropping as a result of image stabilization could also produce undesirable results.

It would thus be desirable to provide a method and system that overcome these shortcomings.

### SUMMARY OF THE INVENTION

The invention is defined by the claims. The invention, in broader aspects, provides a method for altering a video sequence. In the method, a first portion of the video sequence is digitally stabilized in accordance with an initial set of image stabilization parameters and displayed to a user. An input from the user is accepted during the displaying. The user input defines a revised set of image stabilization parameters. A second portion of the video sequence is then digitally stabilized in accordance with the revised set of image stabilization parameters and is displayed to the user. A predetermined video frame rate is maintained continuously during and between the displaying steps.

It is an advantageous effect of the invention that improved methods and systems are provided, in which a user can control image stabilization during video sequence playback.

### BRIEF DESCRIPTION OF THE DRAWINGS

The above-mentioned and other features and objects of this invention and the manner of attaining them will become more apparent and the invention itself will be better understood by reference to the following description of an embodiment of the invention taken in conjunction with the accompanying figures wherein:

FIG. 1 is a diagrammatical view of an embodiment of the system.

FIG. 2 is a diagrammatic view of another embodiment of the system.

FIG. 3 is a diagrammatic view of still another embodiment of the system.

FIG. 4 is a function diagram of the embodiments of FIGS. 1-3. Levels of detail differ as to particular features in the different figures.

FIG. 5 is a diagrammatical view illustrating an image stabilization provided by the system of FIG. 1.

FIG. 6 is a flow chart of an embodiment of the method.

### DETAILED DESCRIPTION OF THE INVENTION

With the invention, a user can change image stabilization during recreational viewing of a video sequence, without distractions of waiting and/or discontinuities in the playback of the video sequence. User input controls for the image stabilization can be provided in an input device, such as a dedicated remote control or as a part of a common remote control for the system.

In the method and system, a first portion of a video sequence is stabilized in accordance with an initial set of image stabilization parameters and is then displayed. While the first portion is being displayed, a user input is accepted, which defines a revised set of image stabilization parameters that differ from the initial set. A second portion of the video sequence is then stabilized in accordance with the revised set of image stabilization parameters and displayed. The displaying is maintained at a predetermined video frame rate, such that there is no discontinuity during or between the first and second portions.

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art. The use of singular and/or plural in referring to the “method” or “methods” and the like is not limiting.

The term “display”, as used herein, is inclusive of any devices that produce light images, including emissive panels, reflective panels, and projectors. The “display” is not limited to separate displays, but rather is inclusive of displays that are parts of other apparatus, such as the display of a cell phone or television or personal video player. A display presents videos at a particular video frame rate. The video frame rate is predetermined by the source material and the capabilities of the display and other components of the system. In the video sequences herein, it is preferred that the frame rate is twenty-four frames per second or greater, since slower rates tend to have an objectionable flicker. A convenient rate is thirty frames/second, since this rate is commonly used for broadcasting consumer video.

The term “rendering” and like terms are used herein to refer to digital processing that modifies an image record so as to be within the limitations of a particular output device. Such limitations include color gamut, available tone scale, and the like.

In the following description, some features are described as “software” or “software programs”. Those skilled in the art will recognize that the equivalent of such software can also be readily constructed in hardware. Because image manipulation algorithms and systems are well known, the present description emphasizes algorithms and features forming part of, or cooperating more directly with, the method. General features of the types of computerized systems discussed herein are well known, and the present description is generally limited to those aspects directly related to the method of the invention. Other aspects of such algorithms and apparatus, and hardware and/or software for producing and otherwise processing the image signals involved therewith, not specifically shown or described herein may be selected from such systems, algorithms, components, and elements known in the art. Given the description as set forth herein, all additional software/hardware implementation is conventional and within the ordinary skill in the art.

It should also be noted that the present invention can be implemented in a combination of software and/or hardware and is not limited to devices, which are physically connected and/or located within the same physical location. One or more of the components illustrated in the figures can be located remotely and can be connected via a network. One or more of the components can be connected wirelessly, such as by a radio-frequency link, either directly or via a network.

The present invention may be employed in a variety of user contexts and environments. Exemplary contexts and environments include, without limitation, use on stationary and mobile consumer devices, wholesale and retail commercial use, use on kiosks, and use as a part of a service offered via a network, such as the Internet or a cellular communication network.

It will be understood that the circuits shown and described can be modified in a variety of ways well known to those of skill in the art. It will also be understood that the various features described here in terms of physical circuits can be alternatively provided as firmware or software functions or a combination of the two. Likewise, components illustrated as separate units herein may be conveniently combined or shared. Multiple components can be provided in distributed locations.

A digital image includes one or more digital image channels or color components. Each digital image channel is a two-dimensional array of pixels. Each pixel value relates to the amount of light received by the imaging capture device corresponding to the physical region of pixel. For color imaging applications, a digital image will often consist of red, green, and blue digital image channels. Motion imaging applications can be thought of as a sequence of digital images. Those skilled in the art will recognize that the present invention can be applied to, but is not limited to, a digital image channel for any of the herein-mentioned applications. Although a digital image channel is described as a two dimensional array of pixel values arranged by rows and columns, those skilled in the art will recognize that the present invention can be applied to non-rectilinear arrays with equal effect.

In each context, the invention may stand alone or may be a component of a larger system solution. Furthermore, human interfaces, e.g., the scanning or input, the digital processing, the display to a user, the input of user requests or processing instructions (if needed), the output, can each be on the same or different devices and physical locations, and communication between the devices and locations can be via public or private network connections, or media based communication. Where consistent with the disclosure of the present invention, the method of the invention can be fully automatic, may have user input (be fully or partially manual), may have user or operator review to accept/reject the result, or may be assisted by metadata additional to that elsewhere discussed (such metadata that may be user supplied, supplied by a measuring device, or determined by an algorithm). Moreover, the methods may interface with a variety of workflow user interface schemes.

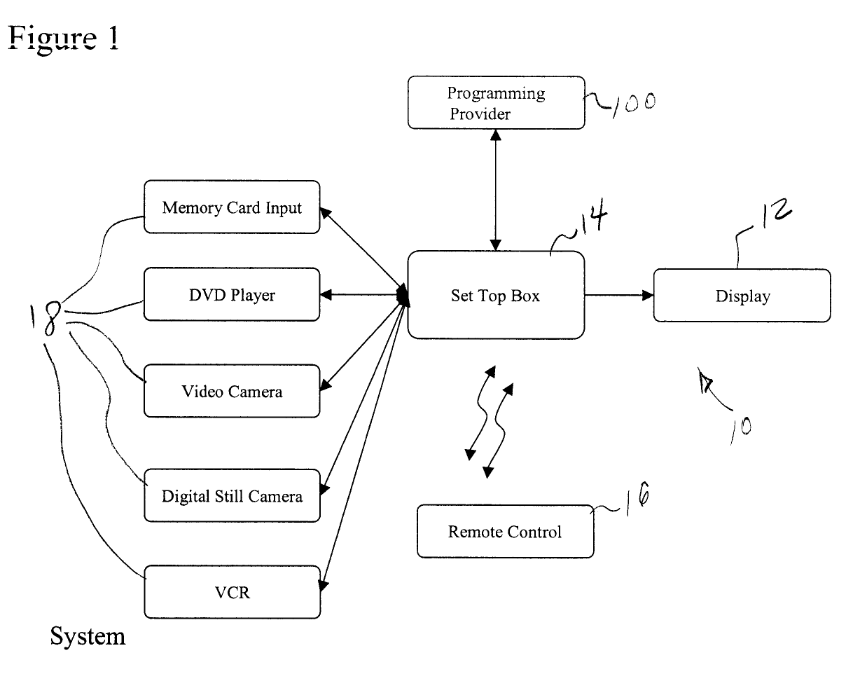

FIG. 1 shows an embodiment of the system 10. In this embodiment, the system is a home entertainment system, which contains a display device 12, such as a television, along with a connected set-top box 14 and remote 16. Other connected peripheral devices 18 are also shown. The connections may be wired or wireless. The display device is not limited to a television, but may also be, for example, a monitor or a portable video display device. Peripheral devices may include, but are not limited to, videocassette recorders, digital video disc players, computers, digital cameras, and card readers. The set-top box provides functions including, but not limited to analog tuning, digital channel selection, and program storage. A variety of input sources are provided. The figure shows: programming provider, memory card input, DVD player, video camera, digital still/video camera, and VCR. Other sources, such as monitoring cameras and Internet television, are well known to those of skill in the art. The display, in this embodiment, can be in the form of a television or a television receiver and separate monitor. A remote control wirelessly connects to the set top box for user input.

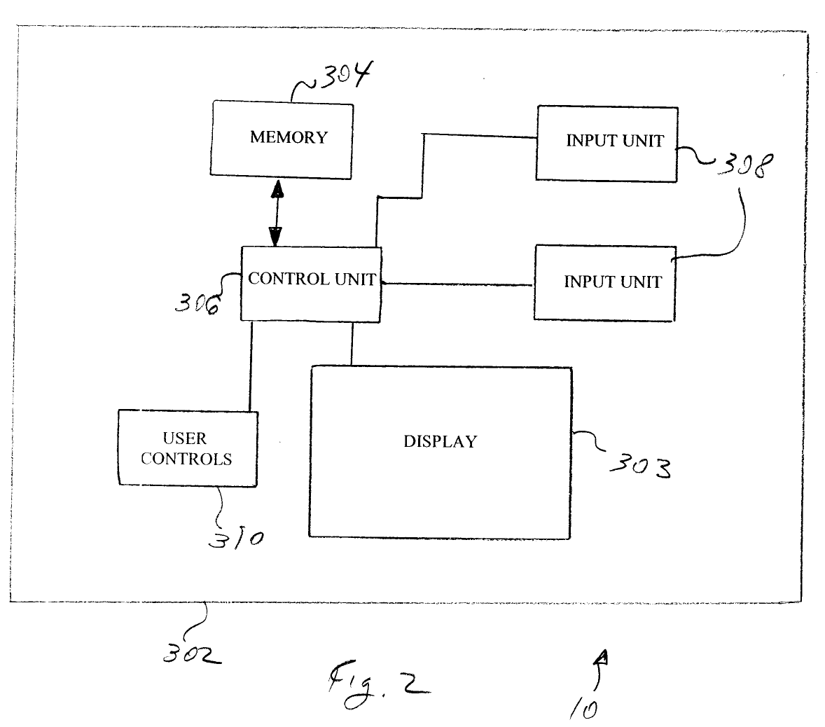

FIG. 2 illustrates another embodiment of the system. In this embodiment, viewable output is displayed using a one-piece portable display device, such as a DVD player, personal digital assistants (PDA), digital still/video camera, or cell phone. The device has a housing 302, display 303, memory 304, a control unit 306, input units 308, and user controls (also referred to as “input devices”) 310 connected to the control unit 306. Components 302, 304, 306, 308, 310 are connected by signal paths 314 and, in this embodiment, the system components and signal paths are located within the housing 302 as illustrated.

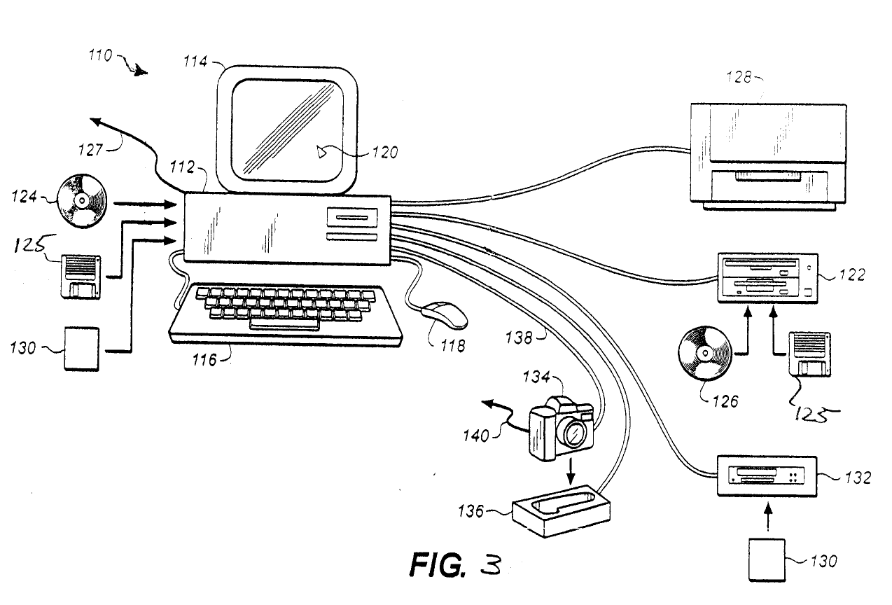

The system can also take the form of a portable computer, a kiosk, or other portable or non-portable computer hardware and computerized equipment. In all cases, one or more components and signal paths can be located in whole or in part outside of the housing. An embodiment including a desktop computer and various peripherals is shown in FIG. 3. The computer system 110 includes a control unit 112 (illustrated in FIG. 3 as a personal computer) for receiving and processing software programs and for performing other processing functions. A display 114 is electrically connected to the control unit 112. Input devices, in the form of a keyboard 116 and mouse 118 are also connected to the control unit 112. Multiple types of removable memory can be provided (illustrated by a CD-ROM 124, DVD 126, floppy disk 125, and memory card 130) along with appropriate components for reading and writing (CD/DVD reader/writer and disk drive 122, memory card reader 132). Memory can be internal or external and accessible using a wired or wireless connection, either directly or via a local or large area network, such as the Internet. A digital camera 134 can be intermittently connected to the computer via a docking station 136, a wired connection 138 or a wireless connection 140. A printer 128 can also be connected to the control unit 112 for printing a hardcopy of the output from the computer system 110. The control unit 112 can have a network connection 127, such as a telephone line, ethernet cable, or wireless link, to an external network, such as a local area network or the Internet.

FIGS. 2 and 3 do not show a list of inputs, but could be used with the same list or a list similar to that of FIG. 1.

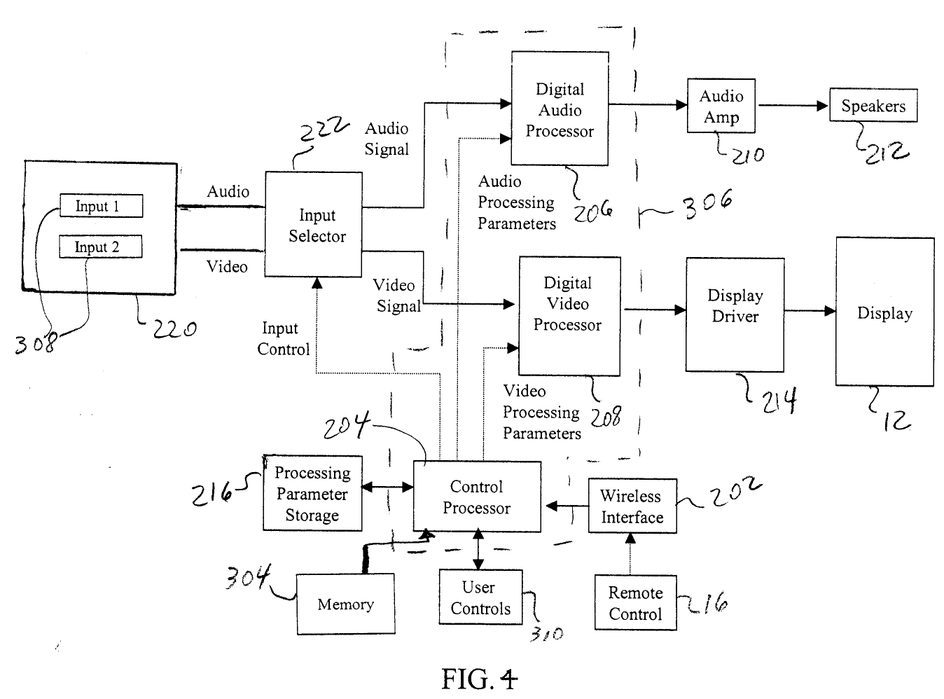

Different components of the system can be completely separate or can share one or more hardware and/or software features with other components. An illustrative diagram of functional components, which is applicable to all of the embodiments of FIGS. 1-3, is shown in FIG. 4. Other features that are not illustrated or discussed are well known to those of skill in the art. For example, a system can be a cell phone camera.

The input devices 310 can comprise any form of transducer or other device capable of receiving an input from a user and converting this input into a form that can be used by the processor. For example, the user interface can comprise a touch screen input, a touch pad input, a 4-way switch, a 6-way switch, an 8-way switch, a stylus system, a trackball system, a joystick system, a voice recognition system, a gesture recognition system, a keyboard, a remote control or other such systems. Input devices can include one or more sensors, which can include light sensors, biometric sensors, and other sensors known in the art that can be used to detect conditions in the environment of system and to convert this information into a form that can be used by processor of the system. Light sensors can include one or more ordinary cameras and/or multispectral sensors. Sensors can also include audio sensors that are adapted to capture sounds. Sensors can also include biometric or other sensors for measuring involuntary physical and mental reactions such sensors including but not limited to voice inflection, body movement, eye movement, pupil dilation, body temperature, and the p4000 wave sensors. Input devices can be local or remote. A wired or wireless remote control 16 that incorporates hardware and software of a communications unit and one or more user controls like those earlier discussed can be included in the system, and acts via an interface 202.

A communication unit or system can comprise for example, one or more optical, radio frequency or other transducer circuits or other systems that convert image and other data into a form that can be conveyed to a remote device such as remote memory system or remote display device using an optical signal, radio frequency signal or other form of signal. A communication system can be used to provide video sequences to an input unit and to provide other data from a host or server computer or network (not separately illustrated), a remote memory system, or a remote input. The communication system provides the processor with information and instructions from signals received thereby. Typically, the communication system will be adapted to communicate with the remote memory system by way a communication network such as a conventional telecommunication or data transfer network such as the Internet, a cellular, peer-to-peer or other form of mobile telecommunication network, a local communication network such as wired or wireless local area network or any other conventional wired or wireless data transfer system.

The system can include one or more output devices including the display. An output device can also include combinations of output, such as a printed image and a digital file on a memory unit, such as a CD or DVD, which can be used in conjunction with any variety of home and portable viewing device such as a personal media player or flat screen TV.

The display has a display panel that produces a light image and an enclosure in which the display panel is mounted. The display may have additional features related to a particular use. For example, the display can be a television.

The control unit can have multiple processors, as in FIG. 4, or can have a single processor providing multiple functions. The control unit can reside in any of the components of the multiple component system and, if the control unit has more than one separable module, the modules can be divided among different components of the system. It is convenient that the control unit is located in the normal path of video sequences of the system and that separate modules are provided, each being optimized for a separate type of program content. For example, with a system having the purpose of home entertainment, it may be convenient to locate the control unit in the television and/or the set-top box. In a particular embodiment, the control unit has multiple separated modules, but the modules are in one of the television and the set-top box.

In the embodiment of FIG. 4, the control unit has a control processor 204, an audio processor 206, and a digital video processor 208. The control processor operates the other components of the system utilizing stored software and data based upon signals from the input devices and the input units. Some operations of the control processor are discussed below in relation to the method. The control processor can include, but is not limited to, a programmable digital computer, a programmable microprocessor, a programmable logic processor, a series of electronic circuits, a series of electronic circuits reduced to the form of an integrated circuit, or a series of discrete components. Necessary programs can be provided on fixed or removable memory or the control processor can be programmed, as is well known in the art, for storing the required software programs internally. Different numbers of the processors can be provided, as appropriate or convenient to meet particular requirements, or a single processor control unit can be used. The audio processor provides a signal to an audio amp 210, which drives speakers 212. The digital video processors send signals to a display driver 214, which drives the display panel 12. Parameters for the processors are supplied from a dedicated memory 216 or memory 304.

“Memory” refers to one or more suitably sized logical units of physical memory provided in semiconductor memory or magnetic memory, or the like. Memory of the system can store a computer program product having a program stored in a computer readable storage medium. Memory can include conventional memory devices including solid state, magnetic, optical or other data storage devices and can be fixed within system or can be removable. For example, memory can be an internal memory, such as SDRAM or Flash EPROM memory, or alternately a removable memory, or a combination of both. Removable memory can be of any type, such as a Compact Flash (CF) or Secure Digital (SD) type card inserted into a socket and connected to the processor via a memory interface. Other types of storage that are utilized include without limitation PC-Cards, MultiMedia Cards (MMC), or embedded and/or removable hard drives. Data including but not limited to control programs can also be stored in a remote memory system such as a personal computer, computer network or other digital system. In addition to functions necessary to operate the system, the control unit provides stabilization functions for the video sequences, as discussed below in detail. Additional functions can be provided, such as image rendering, enhancement, and restoration, manual editing of video sequences and manual intervention in automated (machine-controlled) operations. Necessary programs can be provided in the same manner as with the control processor. The image modifications can also include the addition or modification of metadata, that is, video sequence-associated non-image information.

The system has one or more input units 220. Each input unit has one or more input ports 308 located as convenient for a particular system. Each input port is capable of transmitting a video sequence to the control unit using an input selector 222. Each input port can accept a different kind of input. For example, one input port can accept video sequences from CD-ROMs, another can accept video sequences from satellite television, and still another can accept video sequences from internal memory of a personal computer connected by a wired or wireless connection. The number and different types of input ports and types of content are not limited. An input port can include or interface with any form of electronic or other circuit or system that can supply the appropriate digital data to the processor. One or more input ports can be provided for a camera or other capture device. For example, input ports can include one or more docking stations, intermittently linked external digital capture and/or display devices, a connection to a wired telecommunication system, a cellular phone and/or a wireless broadband transceiver providing wireless connection to a wireless telecommunication network. As other examples, a cable link provides a connection to a cable communication network and a dish satellite system provides a connection to a satellite communication system. An Internet link provides a communication connection to a remote memory in a remote server. A disk player/writer provides access to content recorded on an optical disk. Input ports can provide video sequences from a memory card, compact disk, floppy disk, or internal memory of a device. One or more input ports can provide video sequences from a programming provider. Such input ports can be provided in a set-top box 150. An input port to a programming provider can include other services or content, such as programs for upgrading image processing and other component functions of the system. For example an input port can include or connect to a cable modem that provides program content and updates—either pushed from the cable head-end, or pulled from a website or server accessible by the system.

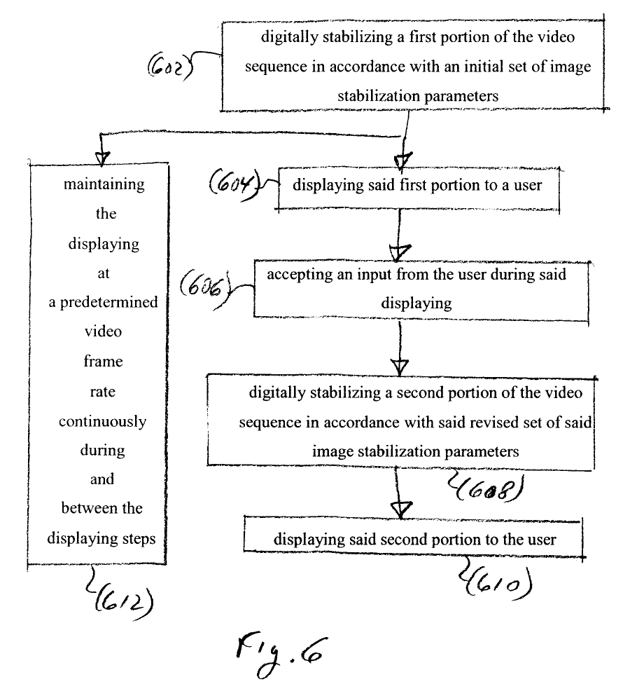

Referring now to FIG. 6, in the method, a video sequence is selected by the user for display. The video sequence can be a consumer video sequence, captured with a handheld device such as, but not limited to, a video-enabled digital still camera, video camcorder or video-enabled cell phone. The video can be of any origin, including professional or commercial content.

A first portion of the video sequence is digitally stabilized 602 in accordance with an initial set of image stabilization parameters. This can be a default set, which can be preset to always be the same or the last set used. The stabilization can be applied anywhere in the system. The stabilization algorithm may reside in the display device, in which case a video is input to the display, which performs the stabilization procedure and displays the stabilized video sequence. The stabilization algorithm may also reside in a set-top box or other processing device external to the display, such that the video is stabilized external to the display, and the display device is only required to display the stabilized video sequence. It is convenient to store the video sequence and set(s) of image stabilization parameters in internal memory of the component, in which the stabilization is performed.

The stabilization algorithm can utilize causal filtering and minimal buffering of decoded images to allow stabilization and display as images are decoded. The stabilization algorithm can also buffer multiple images in memory, allowing non-causal temporal filtering of global motion estimates, and resulting in a slightly longer delay prior to the display of the stabilized video sequence.

The stabilization can crop the frames of the video sequence to a particular pixel resolution. The retained portion is also referred to herein as a cropping window. The cropped out portion is also referred to herein as a “cropping border”. The image stabilization parameters can define a cropping limit, in terms of the minimal pixel resolution to be provided by the cropping.

In a particular embodiment, the stabilization algorithm is described in U.S. Patent Application Publication No. US2006/0274156A1, filed by Rabbani et al. May 17, 2005, entitled “IMAGE SEQUENCE STABILIZATION METHOD AND CAMERA HAVING DUAL PATH IMAGE SEQUENCE STABILIZATION”, which is hereby incorporated herein by reference.

In that stabilization method, input video sequences are analyzed to determine jitter. An output window is mapped onto the input images based on the determined jitter. The mapping at least partially compensates for the jitter. The input images are cropped to the output window to provide corresponding output images. The cropping can replace the input images in memory with the corresponding output images or can retain both input images and output images in memory. With typical memory storage, the image information is stored in a buffer that is arranged in raster scan fashion. The method moves this data in an integer shift of the data horizontally and vertically. This shift introduces no distortions in the image data and can be done very quickly.

In one modification of that stabilization method, it is possible to provide fast digital stabilization of image sequences using moderate processing resources. In that case, the method is rearward-looking, that is, only past and current image frames are used in the image stabilization. Alternatively, the method can be both rearward-looking and forward-looking, that is past, current, and future image frames are used in the image stabilization.

In the stabilization, the movement of the output window is based upon a comparison of composite projection vectors of the motion between the two different images in two orthogonal directions. The first stabilizer has a motion estimation unit, which computes the motion between two images of the sequence. The composite projection vectors of each image are combinations of non-overlapping partial projection vectors of that image in a respective direction. In a particular embodiment, the motion is computed only between successive images in the sequence. Those skilled in the art will recognize, however, that given sufficient computational and memory resources, motion estimates captured across multiple frames can also be computed to increase the robustness and precision of individual frame-to-frame motion estimates.

In the particular embodiment, the motion estimation unit provides a single global translational motion estimate, comprising a horizontal component and a vertical component. The motion estimates are then processed by the jitter estimation unit to determine the component of the motion attributable to jitter. The estimated motion can be limited to unintentional motion due to camera jitter or can comprise both intentional motion, such as a camera pan, and unintentional motion due to camera jitter.

In a particular embodiment, integral projection vectors are used in the production of the global motion vector. Full frame integral projections operate by projecting a two-dimensional image onto two one-dimensional vectors in two orthogonal directions. These two directions are aligned with repeating units in the array of pixels of the input images. This typically corresponds to the array of pixels in the electronic imager. For convenience herein, discussion is generally limited to embodiments having repeating units in a rectangular array the two directions are generally referred to as “horizontal” and “vertical”. It will be understood that these terms are relative to each other and do not necessarily correspond to major dimensions of the images and the imager.

Horizontal and vertical full frame integral projection vectors are formed by summing the image elements in each column to form the horizontal projection vector, and summing the elements in each row to form the vertical projection vector. The vertical projection vector is formed by summing various data points within the overall Y component image data. In a particular embodiment, only a subset of the image data is used when forming the vertical projection vector. Using only a subset of the image data allows for reduced computational complexity of the motion estimation algorithm. The formation of the horizontal projection vector is similar. In a particular embodiment, only a subset of the image data is used when forming the horizontal projection vector. Using only a subset of the image data allows for reduced computational complexity of the motion estimation algorithm.

Much of the burden of estimating motion via integral projections resides in the initial computation of the projection vectors. If necessary, this complexity can be reduced in two ways. First, the number of elements contributing to each projection sum can be reduced by subsampling. For example, when summing down columns to form the horizontal projection vector, only every other element of a column is included in the sum. A second subsampling can be achieved by reducing the density of the projection vectors. For example, when forming the horizontal projection vector, including only every other column in the projection vector. This type of subsampling reduces complexity even more because it also decreases the complexity of the subsequent matching step to find the best offset, but it comes at a cost of reduced motion resolution.

The subset of imaging data to be used for the horizontal and vertical projection vectors can be selected heuristically, with the understanding that reducing the number of pixels reduces the computational burden, but also decreases accuracy. For accuracy, it is currently preferred that total subsampling reduce the number of samples by no more than a ratio of 4:1-6:1.

Non-overlapping partial projection vectors are computed for each of the images. These are projection vectors that are limited to different portions of the image. The motion estimate is calculated from these partial projection vectors. The use of these partial projection vectors rather than full frame projection vectors reduces the effect of independently moving objects within images on the motion estimate. Once the partial projection vectors have been computed for two frames, the horizontal and vertical motion estimates between the frames can be evaluated independently.

Corresponding partial projection vectors are compared between corresponding partial areas of two images. Given length M horizontal projection vectors, and a search range of R pixels, the partial vector of length M−2R from the center of the projection vector for frame n−1 is compared to partial vectors from frame n at various offsets. The comparison yielding the best match is chosen as a jitter component providing the motion estimate in the respective direction. The best match is defined as the offset yielding the minimum distance between the two vectors being compared. Common distance metrics include minimum mean absolute error (MAE) and minimum mean squared error (MSE). In a particular embodiment, the sum of absolute differences is used as the cost function to compare to partial vectors, and the comparison having lowest cost is the best match.

The partial vector of length M−2R from the center of the projection vector for frame n−1 is compared to a partial vector from frame n at an offset. The partial vectors are also divided into smaller partial vectors that divide the output window into sections. Individual costs can be calculated for each partial vector as well as for full frame vectors calculated separately or by combining respective partial frame vectors into composite vectors. If the differences (absolute value, or squared) are combined, the full frame integral projection distance measure is obtained. The final global motion estimate can be selected from among all the best estimates. This flexibility makes the integral projection motion estimation technique more robust to independently moving objects in a scene that may cause the overall image not to have a good match in the previous image, even though a smaller segment of the image may have a very good match.

In a particular embodiment, quarters are combined to yield distance measures for half-regions of the image. In addition to or instead of computing an offset for the best match over all four quarters, individual offsets can be computed for the best match for each of the half-regions as well. These additional offsets can increase the robustness of the motion estimation, for example, by selecting the median offset among the five possible, or by replacing the full-region offset with the best half-region offset if the full-region offset is deemed unreliable.

Improved precision in the motion estimation process can be achieved by interpolation of the projection vectors. A projection vector of size n is interpolated to a vector of size 2n−1 by replicating the existing elements at all even indices of the interpolated vector, and assigning values to elements at odd-valued indices equal to the average of the neighboring even-valued indices. This process can be achieved efficiently in hardware or software with add and shift operations.

Since the summation function used in integral projections is a linear function, interpolating the projection vector is equivalent to interpolating the original image data and then forming the projection vector. Interpolating the projection vector is significantly lower complexity, however.

In a particular embodiment, the interpolation provides half-pixel offsets. Since the projection operation is linear, the projection vectors can be interpolated, which is much more computationally efficient than interpolating an entire image and forming half-pixel projection vectors from the interpolated image data. The vectors are interpolated by computing new values at the midpoints that are the average of the existing neighboring points. Division by two is easily implemented as a right shift by 1 bit. The resulting vector triplets are evaluated for best match.

The interpolated vectors can be constructed prior to any motion estimate offset comparisons, and the best offset is determined based on the lowest cost achieved using the interpolated vectors for comparison. Alternatively, the non-interpolated vectors from two images are compared first to determine a best coarse estimate of the motion. Subsequently, the interpolated vectors are only compared at offsets neighboring the best current estimate, to provide a refinement of the motion estimate accuracy.

Given the distances associated with the best offset and its two neighboring offsets, the continuous distance function can be modeled to derive a more precise estimate of the motion. The model chosen for the distance measurements depends on whether mean absolute error (MAE) or mean squared error (MSE) is used as the distance metric. If MSE is used as the distance metric, then the continuous distance function is modeled as a quadratic. A parabola can be fit to the three chosen offsets and their associated distances. If MAE is used as the distance metric, then the continuous distance function is modeled as a piecewise linear function.

Once a motion estimate has been computed, it is necessary to determine what component of the motion is desired, due to a camera pan, for example, and what component of the motion is due to camera jitter. In the simple case when the desired motion is known to be zero, all of the estimated motion can be classified as jitter and removed from the sequence. In general, however, there may be some desired camera motion along with the undesirable camera jitter. Typical intentional camera movements are low frequency, no more than 1-2 Hz, while hand tremor commonly occurs at 2-10 Hz. Thus, low-pass temporal filtering can be applied to the motion estimates to eliminate high frequency jitter.

In addition to having a specific frequency response that eliminates high frequency jitter information, the ideal low-pass filter for this stabilization path also needs to have minimal phase delay. During an intentional panning motion, excessive phase delay can result in much of the initial panning motion being misclassified as jitter. In this case, the stabilized sequence lags behind the desired panning motion of the sequence. Zero-phase filters require non-causal filtering, and cause a temporal delay between the capture of an image and its display on the back of the camera. In a particular embodiment, a causal filtering scheme is employed that minimizes phase delay without introducing any temporal delay prior to displaying the stabilized image on the camera display.

In a particular embodiment, the motion estimate is low pass temporal filtered to retain the effects of panning, i.e., intentional camera movement. This filtering relies upon a determination that it is reasonable to assume that any desired camera motion is of very low frequency, no more than 1 or 2 Hz. This is unlike hand shake, which is well known to commonly occur at between 2-10 Hz. Low-pass temporal filtering can thus be applied to the motion estimates to eliminate the high frequency jitter information, while retaining any intentional low frequency camera motion.

In a particular embodiment, the stabilized image sequence is available for viewing during capture. This makes undesirable in such embodiments, non-causal, low pass temporal filtering that causes a temporal delay between the capture of an image sequence and display of that sequence. (Non-causal temporal filtering uses data from previous and subsequent images in a sequence. Causal temporal filtering is limited to previous frames.)

Causal temporal filters, unlike non-causal temporal filters tend to exhibit excessive phase delay. This is undesirable in any embodiment. During an intentional panning motion, excessive phase delay can result in much of the initial panning motion being misclassified as jitter. In this case, the stabilized sequence lags behind the desired panning motion of the sequence.

In a particular embodiment, the global motion estimates are input to a recursive filter (infinite impulse response filter), which is designed to have good frequency response with respect to known hand shake frequencies, as well as good phase response so as to minimize the phase delay of the stabilized image sequence. The filter is given by the formula:

A[n]=αA[n−1]+αv[n].

where:

A[n] is the accumulated jitter for frame n,

v[n] is the computed motion estimate for frame n, and

α is a dampening factor with a value between 0 and 1.

For frame n, the bounding box (also referred to herein as the “output window”) around the sensor image data to be used in the stabilized sequence is shifted by A[n] relative to its initial location. The accumulated jitter is tracked independently for the x direction and y direction, and the term v[n] generically represents motion in one of a respective one of the two directions. As a more computationally complex alternative, the filter can be modified to track motion in both directions at the same time. Preferably, this equation is applied independently to the horizontal and vertical motion estimates.

The damping factor α is used to steer the accumulated jitter toward 0 when there is no motion, and that controls the frequency and phase responses of the filter. The damping factor α can be changed adaptively from frame to frame to account for an increase or decrease in estimated motion. In general, values near one for α result in the majority of the estimated motion being classified as jitter. As α decreases toward zero, more of the estimated motion is retained. The suitable value, range, or set of discrete values of α can be determined heuristically for a particular user or category of users or uses exhibiting similar jitters. Typically, hand shake is at least 2 Hz and all frequencies of 2 Hz or higher can be considered jitter. A determination can also be made as to whether the motion estimate is unreliable, for example, motion estimate is unreliable when a moving object, such as a passing vehicle, is mistakenly tracked even though the camera is steady. In that case, the jitter accumulation procedure is modified, by user input or automatically, so as not to calculate any additional jitter for the current frame. The accumulated jitter is, preferably, kept constant if the motion estimate is determined to be unreliable.

The maximum allowed jitter correction is also constrained. To enforce this constraint, values of A[n] greater than this limit are clipped to prevent correction attempts beyond the boundaries of the original captured image.

In a particular application in which computational resources are constrained, the jitter correction term is rounded to the nearest integer to avoid the need for interpolation. For YCbCr data in which the chrominance components are sub-sampled by a factor of two in the horizontal direction, it may also be necessary to round the jitter correction to the nearest multiple of two so that the chrominance data aligns properly.

Another stabilization procedure, referred to for convenience as “the second procedure”, is now described in greater detail. In the second procedure, when the jitter component of the motion for frame n is computed, motion estimates from previous and future frames exist, to allow more accurate calculation of jitter than in the earlier described stabilization procedure, which relies only on current and previous motion estimates.

In the second procedure, the buffering and jitter computation scheme includes motion estimates for frames n−k through n+k in computing the jitter corresponding to frame n. As frame n+k becomes available for processing, a motion estimation technique is used to compute the motion for the current frame and add it to the array of motion estimates. It is preferred that the jitter is computed using a non-causal low pass filter. The low-pass filtered motion estimate at frame n is subtracted from the original motion estimate at frame n to yield the component of the motion corresponding to high frequency jitter. The accumulated jitter calculation is given by the following equations:

$$j [ n ] = v [ n ] - {\sum }_{i = n - k}^{n + k} v [ i ] h [ n - i ]$$

$$A [ n ] = A [ n - 1 ] + j [ n ] ,$$

where j[n] is the jitter computed for frame n. It is the difference between the original motion estimate, v[n], and the low-pass filtered motion estimate given by convolving the motion estimates, v[ ], with the filter taps, h[ ]. The accumulated jitter, A[n], is given by the summation of the previous accumulated jitter plus the current jitter term. A[n] represents the desired jitter correction for frame n. Given the desired jitter correction term A[n], frame n is accessed from the image buffer, which holds all images from frame n to frame n+k. The sensor data region of frame n to be encoded is adjusted based on A[n]. This data is passed to the video encoder or directly to memory for storage without compression.

The specific value of k used by the filtering and buffering scheme can be chosen based on the amount of buffer space available for storing images or other criteria. In general, the more frames of motion estimates available, the closer the filtering scheme can come to achieving a desired frequency response. The specific values of the filter taps given by h[ ] are dependent on the desired frequency response of the filter, which in turn is dependent on the assumed frequency range of the jitter component of the motion, as well as the frame rate of the image sequence.

Other stabilization algorithms with varying computational complexity can also be used. Such methods are described in Park et al. U.S. Pat. No. 5,748,231, Soupliotis et al. U.S. Patent Application 2004/0001705, Morimura et al. U.S. Pat. No. 5,172,226, Weiss et al. U.S. Pat. No. 5,510,834, Burt et al. U.S. Pat. No. 5,629,988, Lee U.S. Patent Application 2002/0118761, Paik et al. (IEEE Transactions on Consumer Electronics, Vol. 38, No. 3, August 1992), and Uomori et al. (IEEE Transactions on Consumer Electronics, Vol. 36, No. 3, August 1990). These techniques differ in the approaches used to derive estimates of the camera motion, as well as the image warping and cropping used to generate the stabilized image sequence. These algorithms can be used individually or in combination to generate a robust estimate of the camera motion and subsequent stabilized image sequence.

In a particular embodiment, the first portion of the video sequence is analyzed prior to display to determine an initial set of image stabilization parameters, which provide an optimal cropping border size that allows sufficient room for stabilization without unnecessarily sacrificing resolution. For example, to achieve similar results, a generally steady video capture can be stabilized using a much smaller border region than a shaky video capture. The cropping border determined by the analysis remains in use until modified responsive to an input from the user. If no input is received, the cropping border provided by the analysis continues in use for the entire video sequence.

After the first portion is stabilized, it is displayed 604 to the user. During this display, the user can actuate the input device to transmit to a control unit, a user input that defines a revised set of image stabilization parameters that differ from the initial set of image stabilization parameters. The input device has a plurality of states. Each state corresponds to different steps of motion compensation provided by the stabilizing. The steps can include a base state defining no motion compensation (also referred to as “image stabilization deselected”). The input device is actuable (that is, can be actuated) to provide a user input corresponding to each of the states.

The control unit checks on whether such a user input has been received and, if so, accepts 606 the input and determines an altered image stabilization for a second portion of the video sequence. (The second portion follows the first portion, but may or may not be continuous with the first portion, although that is preferred. If time is needed, the stabilization used for the first portion can be continued until the stabilization for the second portion is ready. Alternatively, an intermediate stabilization in some form or even no stabilization could be provided between the first and second portions.)

In a particular embodiment of the proposed invention, a user has the option to select and deselect the stabilization processing. This selection can occur before the video display begins as an initial stabilization, or at any time during the video display. If stabilization is deselected during the video display, the algorithm may choose to automatically re-center the cropping window in the central region of the image, it may choose to leave the cropping window at the location of the last stabilized frame, or it may choose to allow the cropping window to slowly drift back to the central region of the image. When stabilization is reselected, the algorithm can continue with the cropped window at its current location.

In a preferred embodiment of the proposed invention, the user additionally has the option to select a degree of desired stabilization. This setting can affect, for example, the cropping window size. As a user requests a greater degree of stabilization, the cropping window size may shrink, equivalently increasing the size of the border data, allowing a greater stabilization offset. This setting can also affect the filtering coefficients used to control the component of the estimated motion that is classified as jitter. As a user requests a greater degree of stabilization, the filter coefficients are adjusted so that a larger component of the estimated motion is classified as jitter. This setting can also affect the maximum amount of motion between any given frame pair that can be classified as jitter. As a user requests a greater degree of stabilization, the maximum frame jitter threshold is increased, allowing more motion to be classified as jitter. These settings can be modified individually by the user, or in automatic combination in response to a single user-adjusted control. The selection of a varying degree of desired stabilization can occur before the video display begins, or at any time during the video display.

The digital stabilizing is next applied 608 to the second portion of the video sequence in accordance with the revised set of image stabilization parameters. The revision can be an alteration of the cropping limit. The revision can alters the cropping limit to a larger final pixel resolution. In that case, the cropping window is recentered for the second portion of the video sequence relative to the frames of the video sequence prior to the stabilizing steps.

The second portion is then displayed 610 to the user. The displaying of the first and second portions is preferably maintained 612 in a continuous stream concurrent with the stabilizing. That is, the video sequence is continuously at a predetermined video frame rate during and between the displaying steps.

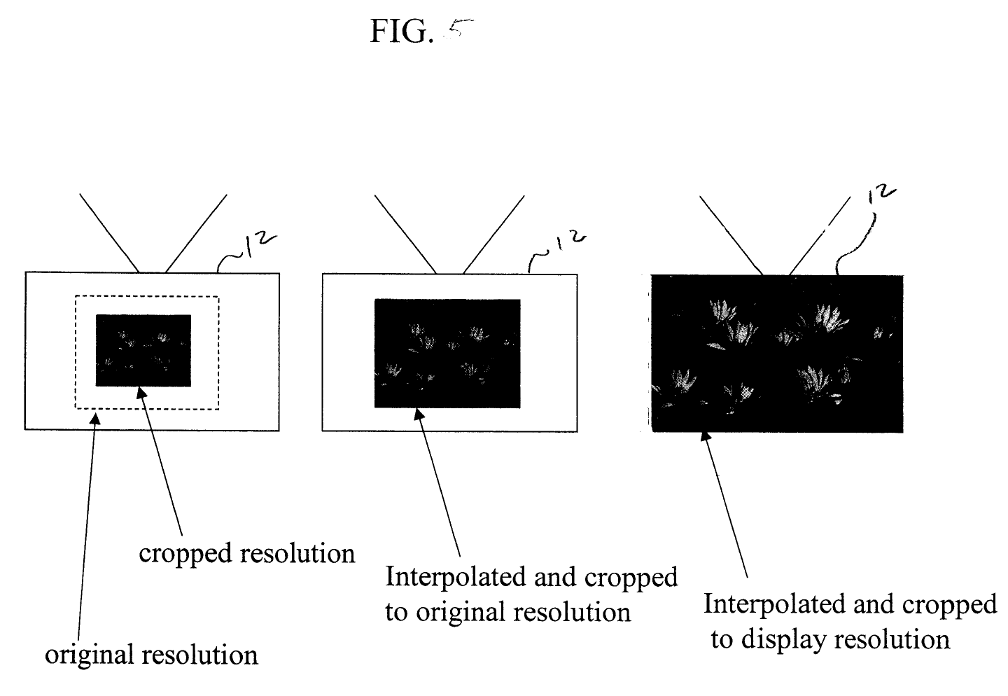

As illustrated in FIG. 5, the stabilized video can be displayed at its cropped resolution, or it can be interpolated and cropped to match the resolution of the original video, or it can be scaled and cropped to any target resolution, including that of the display device. If the stabilized video is displayed at a cropped resolution, a black border can be used outside of the cropped window, or letterbox can surround the cropped window. The cropped window can be of any shape. In a particular embodiment, however, the cropped window is a rectangle having the same aspect ratio as the original video resolution.

Following the stabilization of the video sequence, the stabilized video can be written to memory, either overwriting the original video sequence, or as separate video data. Alternatively, metadata can be recorded in association with respective frames of the video sequence, indicating respective sets of image stabilization parameters. For example, metadata can define the locations of cropping borders for each of the frames. Use of metadata allows optimized future viewing of the video to occur, using a processor that can properly interpret the metadata and generate the stabilized video sequence, without repeating the entire stabilization algorithm.

In a particular embodiment, the analysis computes global motion vectors and a value for accumulated jitter using the formula

A[n]=αA[n−1]+αv[n].

as described previously, without using any predefined maximum allowable value for A[n]. The sequence of values A[n] is evaluated for all video frames, n, and the maximum value is chosen as the optimal cropping border size. That is,

$${max}_{n} A [ n ]$$

is chosen as the optimal cropping border size. This approach can have the problem that the value returned by

$${max}_{n} A [ n ]$$

is large, resulting in a stabilized video with low remaining spatial resolution. To avoid this problem, the optimal cropping border can be defined as

$$min ( {max}_{n} A [ n ] , k ) ,$$

where k is a predefined cropping limit that defines a maximum acceptable loss of resolution. For example, for a 640×480 VGA resolution video sequence, it may be decided that a maximum tolerable loss of resolution is a border of 40 pixels in the horizontal axis and 30 pixels in the vertical axis. Such an cropping limit ensures that the resolution of the stabilized video does not drop below a set threshold, and chooses smaller cropping borders for videos with less jitter to remove. An indication of the predefined cropping limit can be stored in memory and be retrieved as needed. The cropping limit can be a particular resolution for all video sequences or can be a function of the resolution of the original video sequence.

Another method for analyzing a video sequence before display to determine an optimal border size is to generate statistics, such as variance, maximum, and first-order differences, associated with the global motion vectors of all or a subset of the video frames of the sequence. These statistics can then be used to derive an entry in a look-up table, which determines the border size to be used for the given video. The look-up table can be determined heuristically.

The video analysis can be a quick decision based on only a few frames of data, or it may be a more complete analysis of all of the frames of the first portion of the video sequence. In another embodiment, a cropping border size is incorporated in metadata of a video sequence. In that case, the cropping border for the first portion of the video sequence is determined from the metadata.

The method is particularly advantageous for use with digital image stabilization procedures that crop some of the available pixels of the frames of the video sequence. It can be expected that in most cases, this will be acceptable to a user, in order to provide the benefit of image stabilization. It can also be expected that in some cases, the user will prefer to retain the larger pixel resolution, in order to keep viewable the subject matter in the pixels that would otherwise be discarded. For example, the video camera may have been pointed in an off-center direction during capture or, the user considers the wider viewing angle to be more important than reduction of image stabilization. Another advantage that can be provided is that the default image stabilization parameters can be set relatively aggressively, that is, so as to remove more motion from a portion of the video sequence. This can be beneficial if a video sequence has a large amount of jitter, but is detrimental if the image stabilization procedure attempts to remove motion that is due to panning or the like. With the invention, the user can make corrections as needed, and a dedicated editing session is unnecessary, for the purpose of making those corrections, since the corrections can be easily made during ordinary viewing. The invention also makes it easy for the user to learn how to apply different amounts of image stabilization.

The invention has been described in detail with particular reference to certain preferred embodiments thereof, but it will be understood that variations and modifications can be effected within the spirit and scope of the invention.

1. A method for altering a video sequence, the method comprising the steps of:
digitally stabilizing a first portion of the video sequence in accordance with an initial set of image stabilization parameters;
displaying said first portion to a user;
accepting an input from the user during said displaying, said user input defining a revised set of said image stabilization parameters;
digitally stabilizing a second portion of the video sequence in accordance with said revised set of said image stabilization parameters, said second portion following said first portion;
displaying said second portion to the user;
maintaining said displaying at a predetermined video frame rate continuously during and between said displaying steps.

2. The method of claim 1 wherein said digitally stabilizing of said first portion further comprises applying a default set of said image stabilization parameters.

3. The method of claim 1 wherein said digitally stabilizing of said first portion further comprises analyzing said first portion and determining said initial set of image stabilization parameters responsive to said analyzing.

4. The method of claim 3 wherein said determining further comprises computing a maximum accumulated jitter of frames of the video sequence.

5. The method of claim 4 wherein said determining further comprises retrieving a preset initial cropping limit and maintaining said stabilizing of said first portion within said cropping limit.

6. The method of claim 1 wherein said input device is selectively actuable in one of a plurality of different states to generate said input, said input device in each said state generating a respective said user input defining a different revision of said set of image stabilization parameters.

7. The method of claim 6 wherein said states include a plurality of states corresponding to different relative increases in motion compensation provided by said stabilizing and a plurality of states corresponding to different relative decreases in motion compensation provided by said stabilizing.

8. The method of claim 7 wherein said states include a base state defining no motion compensation.

9. The method of claim 1 wherein said stabilizing further comprises cropping frames of respective said portions of said video sequence and said sets of image stabilization parameters each include a respective cropping limit, said cropping limit defining a final pixel resolution less than an initial pixel resolution of said frames prior to said stabilizing.

10. The method of claim 9 wherein said revision of said set of image stabilization parameters alters the cropping limit.

11. The method of claim 10 wherein said revision alters the cropping limit to a larger final pixel resolution and said method further comprises recentering said second portion of said video sequence relative to the frames of said video sequence prior to said stabilizing steps.

12. The method of claim 9 wherein said stabilizing steps define a plurality of cropping borders, each said border being associated with a respective said frame, and said method further comprises recording metadata indicating said cropping borders in association with respective said frames.

13. The method of claim 9 wherein:
said stabilizing steps each further comprise:
computing frame-to-frame motion in the respective said portion; and
determining a jitter component of said motion;
comparing said jitter component to a threshold; and
said revision alters said threshold.

14. The method of claim 1 wherein:
said stabilizing steps each further comprise:
computing frame-to-frame motion in the respective said portion; and
determining a jitter component of said motion;
comparing said jitter component to a threshold; and
said revision alters said threshold.

15. The method of claim 1 further comprising:
generating metadata defining a digital stabilization of the video sequence in accordance with said revised set of said image stabilization parameters; and
storing said metadata in association with said video sequence.

16. The method of claim 1 further comprising setting said initial set of image stabilization parameters to values for a predefined optimal cropping border size.

17. The method of claim 16 wherein said setting further comprises calculating said initial set of image stabilization parameters based on both a maximum accumulated jitter in said first portion and a predetermined maximum acceptable loss of resolution during said stabilizing.

18. A method for altering a video sequence, the method comprising the steps of:
digitally stabilizing a first portion of the video sequence in accordance with a default set of image stabilization parameters;
displaying said first portion to a user;
accepting an input from the user during said displaying, said input being from an input device selectively actuable in one of a plurality of different states to generate said input, in each said state said input defining a different revised set of said image stabilization parameters;
digitally stabilizing a second portion of the video sequence in accordance with the respective said revised set of said image stabilization parameters, said second portion following said first portion;
displaying said second portion to the user;
maintaining said displaying at a predetermined video frame rate continuously during and between said displaying steps;
wherein said stabilizing further comprises cropping frames of respective said portions of said video sequence.

19. A system for altering a video sequence, the method comprising the steps of:
a memory storing the video sequence and an initial set of image stabilization parameters;
an input device transmitting a user input defining a revised set of said image stabilization parameters to a control unit;
said control unit being operatively connected to said input device and said memory, said control unit digitally stabilizing a first segment of said video sequence in accordance with said initial set of image stabilization parameters prior to said transmitting and digitally stabilizing a second segment of said video sequence in accordance with said revised set of image stabilization parameters following said transmitting; and
a display operatively connected to said control unit, said display displaying said segments in a continuous stream concurrent with said stabilizing.

20. The system of claim 19 wherein said control unit crops frames of the video sequence during said stabilizing, said sets of image stabilization parameters each include a respective cropping limit, said cropping limit defining a final pixel resolution less than an initial pixel resolution of said frames prior to said stabilizing, and said revision of said set of image stabilization parameters alters the cropping limit.

21. The system of claim 19 wherein said input device is selectively actuable in one of a plurality of different states, said input device in each said state generating a respective said user input defining a different revision of said set of image stabilization parameters.

22. The system of claim 21 wherein said states include a plurality of states corresponding to different relative increases in motion compensation provided by said stabilizing, a plurality of states corresponding to different relative decreases in motion compensation provided by said stabilizing, and a base state defining no motion compensation.

23. The system of claim 19 wherein said control unit records metadata indicating said sets of image stabilization parameters in said memory in association with respective said portions of said video sequence.

24. The system of claim 23 wherein said metadata indicate cropping borders in association with respective frames of said video sequence.

25. The system of claim 19 wherein said initial set of stabilization parameters is a default set, said video frame rate is greater than or equal to 24 frames/second, and said input device is a wireless remote.

26. A method for altering a video sequence, the method comprising the steps of:
analyzing a first portion of the video sequence;
determining an initial set of image stabilization parameters responsive to said analyzing;
digitally stabilizing the first portion of the video sequence in accordance with said initial set of image stabilization parameters;
displaying the first portion to a user;
during said displaying of said first portion, checking on whether an input has been received from a user, said user input defining a revised set of said image stabilization parameters;
digitally stabilizing a second portion of the video sequence in accordance with said revised set of said image stabilization parameters, when said input is received;
digitally stabilizing the second portion of the video sequence in accordance with said initial set of image stabilization parameters, when said input is absent;
displaying said second portion to the user; and
maintaining said displaying at a predetermined video frame rate continuously during and between said displaying steps.

27. The method of claim 26 wherein said determining further comprises computing a maximum accumulated jitter of frames of the video sequence.

28. The method of claim 27 wherein said determining further comprises retrieving a preset initial cropping limit and maintaining said stabilizing of said first portion within said cropping limit.
